(19) United States
(12) Patent Application Publication
(10) Pub. No.: US 2014/0379518 A1
(43) Pub. Date: Dec. 25, 2014

(54) LOCALIZED LIBRARY RECOMMENDATION SYSTEM

(71) Applicant: 3M INNOVATIVE PROPERTIES COMPANY, St. Paul, MN (US)

(72) Inventors: Jack E. Driessen, Lino Lakes, MN (US); Cristina U. Thomas, Stillwater, MN (US); Matthew D. Bellamy, Minneapolis, MN (US); Charles P. Jens, Woodbury, MN (US)

(21) Appl. No.: 13/925,037

(22) Filed: Jun. 24, 2013

(51) Int. Cl. G06Q 30/00

(52) U.S. Cl. CPC G06Q 30/00
USPC 705/26.7

(57) ABSTRACT

A local library recommendation system for recommending an item available for circulation from a local library. The system includes a self checkout device for use by a patron to check out an item from the local library, the self checkout device including a processor, a display for displaying information to the patron, and an item identification component. The item identification component is configured to identify the item being checked out by the patron. The display shows a recommendation of a second item based on the identification of the item being checked out by the patron, and the second item is part of the local library's collection.

### TECHNICAL FIELD

A self checkout or item return system for use in a local library. More specifically, the system includes a display which provides an item recommendation based on an item being checked out or returned by the patron, the recommended item being available for circulation from the local library.

### BACKGROUND

Local libraries have historically offered, and continue to offer, a unique service to their communities. Patrons that visit libraries have access to a variety of media available for lending through a library's collection. A library's collection can include items that a library owns or items that it can lend out to a library card holder through a shared catalog. Media included in a library collection can include books, electronic books (ebooks), CD's, DVD's, journals, cassette tapes, databases, magazines, audio books and any other lendable media. Additionally, library staff members often interact with patrons to provide recommendations for different items based on interests of a particular patron. Recommendation processes within libraries have historically been based on databases made available to librarians or library staff When patrons asked librarians a question, the librarian would be able to search for recommended titles and provide the titles to patrons. The databases could include lists of best-sellers, staff picks, correspondence from other librarians, or other resources. Patrons have also historically received automated recommendations via emails or book clubs.

### SUMMARY

As libraries transition to more automated services, including products that allow a patron to check an item out and return and confirm receipt of items along with placing electronic holds or reservations, patrons are becoming less likely to interact with library staff and are therefore receiving fewer recommendations from library staff members.

In some cases, patrons may search to identify items of interest while at or prior to coming to a library, but may find that their desired item of interest is not available at a local library upon arrival.

Both of these trends can lead to decreased traffic in and circulation volumes for a local library, which in turn can impact library funding and a library's ability to offer additional items and services to a community.

The present invention addresses the issues identified above by providing recommendations for a patron that are limited to content in a library's collection and provided to a patron at a point of item checkout or return. Specifically, the present invention allows a patron to take a further action based on the recommendation.

In one embodiment, the present invention includes a local library recommendation system for recommending an item available for circulation from a local library. The system includes a self checkout device for use by a patron to check out an item from the local library, the self checkout device including a processor, a display for displaying information to the patron, and an item identification component. The item identification component is configured to identify the item being checked out by the patron. The display shows a recommendation of a second item based on the identification of the item being checked out by the patron, and the second item is part of the local library's collection.

In another embodiment, the present invention includes a local library recommendation system for recommending items available for circulation from a local library. The system includes an item return device for use by a patron to return an item to the local library, the return device including a processor, a display for displaying information to the patron and an item identification component. The item identification component is configured to identify the item being returned by the patron. The display shows a recommendation of a second item based on the identification of the item being returned by the patron, and wherein the second item is part of the local library's collection.

### BRIEF DESCRIPTION OF DRAWINGS

The invention may be more completely understood in consideration of the following detailed description of various embodiments of the invention in connection with the accompanying drawings, in which:

FIG. 1 is an exemplary self checkout device for use in a local library.

FIG. 2 is an exemplary item return device for use in a local library.

FIG. 3 is an exemplary user interface that may be displayed on a self checkout or item return device display.

FIG. 4 is an example of a recommendations panel.

In the following description of the illustrated embodiments, reference is made to the accompanying drawings, in which is shown by way of illustration, various embodiments in which the invention may be practiced. It is to be understood that the embodiments may be utilized and structural changes may be made without departing from the scope of the present invention. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

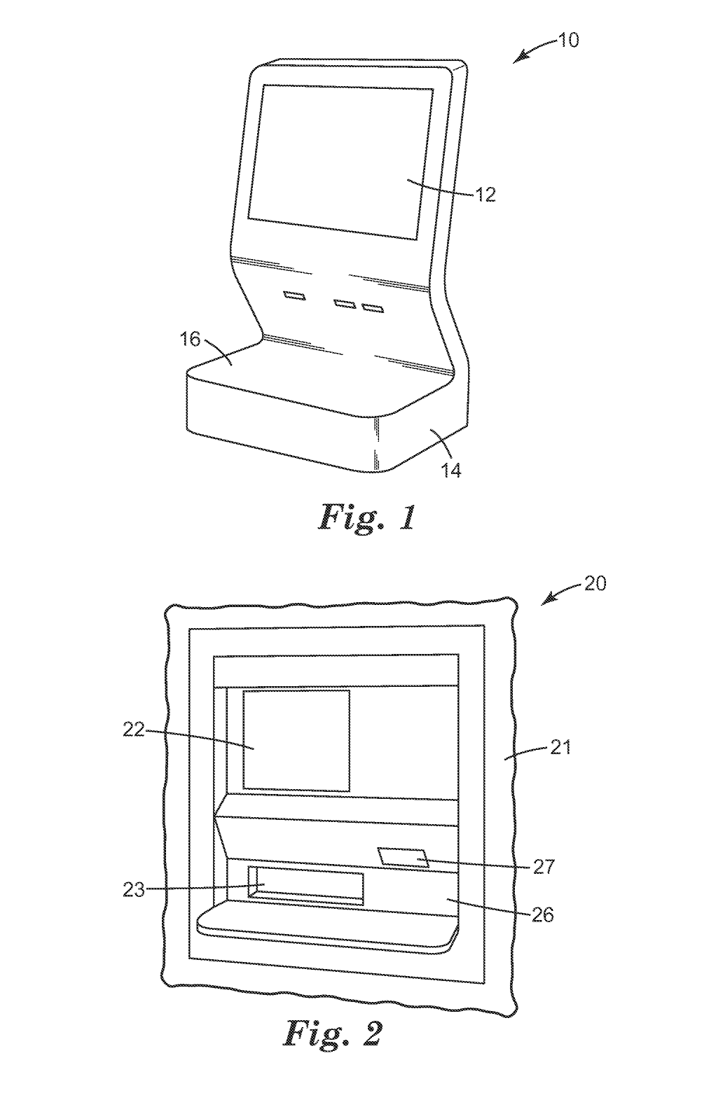

FIG. 1 is an exemplary self checkout device 10 for use in a local library. Self checkout devices generically are offered by a variety of companies and can be used independently by a patron visiting a library to check out items from a library. Self checkout device 10 may also be configured to allow a patron to return an item to a library.

Self checkout device 10 includes at least display 12, processor 14 and item identification component 16. Display 12 can serve as a user interface for a patron interacting with self checkout device 10. Display 12 can provide instructions to a patron, such as indicating when a patron should present identifying information for themselves to the device, such as a library card. Display 12 can further provide information, such as titles of items being checked out by the patron, due dates for such items, outstanding fines for a particular patron and, in this invention, provide recommendations of additional items.

Self checkout device 10 further includes processor 14. Processor 14 can be a computer or any other general purpose processor that can be used to control self checkout device 10, a user interface shown in display 12, and the operation of item identification component 16. In some embodiments, self checkout device may be connected to a network of other self checkout devices which are all controlled by a central processor. Processor 14 may also be in communication with other databases, such as an Integrated Library System (ILS) which stores records related to items available as part of a library's collection.

Item identification component 16 identifies items placed on or near the self checkout device 10 to be checked out by a patron. For example, item identification component 16 may be radio frequency identification (RFID) reader that receives information from an RFID tag adhered to or associated with the item to be checked out. Alternatively, item identification component 16 may be a barcode scanner that scans a barcode attached to or associated with an item to be checked out. The barcode or RFID tag can include an item identification number associated with the item to be checked out, or may include other information related to the item, such as title, ISBN number, or information as to whether the item is checked out.

Self checkout device 10 is configured such that a patron can interact with the device to check out a selected item. As an example, a patron may approach the device and select a button shown on display 12 or otherwise indicate that he intends to check items out from the local library. The patron may then present the items to the item identification component 16 so that it can identify the item by reading identifying information from the RFID tag or barcode associated with the item. In the instance that the item identification component 16 is an RFID reader, the patron may need only place the item or items within the vicinity of the reader in order for information to be read from the RFID tag. In the instance item identification component 16 is a barcode reader, the patron will then place the item in a location so that the barcode is within the line of sight of the barcode scanner.

After information is read from the item or items to be checked out, but prior to a patron completing their session with the self checkout device, the display 12 shows a recommendation for a second item based on identifying information from the item being checked out. The recommendation may be based on one or more items checked out by the patron. The display also presents the patron with an option to take action related to the recommended item or items. A variety of actions may be offered. For example, a patron may choose to print or email identifying information related to the second item. The patron may also choose to place the item on hold, or in the case that the item is digital, to immediately check it out.

The recommended item is one available within the library's collection such that it is an item that a library owns or items that it can lend out to a library card holder through a shared catalog. Media included in a library collection can include books, electronic books (ebooks), CD's, DVD's, journals, cassette tapes, databases, magazines, audio books and any other lendable media. The recommended item may be further limited such that it is part of the local library's available collection. In other words, the item has no current holds and is available for immediate lending to the patron. This avoids a situation where a patron is not able to check out or access recommended items.

The recommended item may be any variety of items. For example, if the item being checked out by the patron is a book, the recommended item does not need to be the same type of media, but may be a CD, DVD, journal, ebook, audio book, or any other type of media. In another configuration, the recommended item may be explicitly limited to the type of item being checked out such that if an audio book is being checked out, the recommended item is also an audio book.

In some configurations, the recommendation may be generated by processor 14 or by another processor associated with the local library. In other instances, the recommendation may be generated by receiving multiple recommendations from a remote processor or system. Those multiple recommendations may then be reduced to only recommendations present in the library's collection to be displayed to a patron. In some instances, a single recommendation or set of recommendations may be based on identifying information from more than one item being checked out. In other instances, multiple recommendations may be based on a single item being checked out.

While key components of a self checkout device 10 are described above, such a device can be configured in a variety of ways. For example, it may have a printer associated with it so that it can print receipts or other information for patrons. Self checkout device 10 may also have a security component to magnetize or demagnetize magnetic security strips disposed in or attached to items being checked out. These additional features are by way of example only. There are a variety of other features and configurations for self checkout device 10 that are consistent with the present disclosure.

FIG. 2 is an exemplary item return device 20 for use in a local library. Item return device 20 is disposed in a wall 21 and on the other side of the wall there is another portion (not shown) of item return device 20 that, in some configurations, may automatically sort materials and items returned to a library by a patron. Item return device 20 can include display 22, item receptacle 23, processor 24, item identification component 26, and printer 27.

When a patron approaches item return device 20, display 22 may provide the patron an option to begin item check in. After the patron chooses that option, they may place items to be returned into item receptacle 23. The items inserted into item receptacle 23 are then identified by item identification component 26 reading identifying information from a barcode or RFID tag associated with or attached to the item.

After information is read from the item or items to be checked out, but prior to a patron completing their session with the self checkout device, the display 22 shows a recommendation for a second item based on identifying information from the item being checked out. The recommendation may be based on one or more items checked out by the patron. The display also presents the patron with an option to take action related to the recommended item or items. A variety of actions may be offered. For example, a patron may choose to print or email identifying information related to the second item. The patron may also choose to place the item on hold, or in the case that the item is digital, to immediately check it out. As with a self checkout device, the recommendation may be any of a plurality of types of items and the recommendation may be part of the library's collection.

Processor 24 can control the operation of item return device 20. Item return device 20 includes printer 27 which may print receipts or other information for a patron.

It will be apparent to one of ordinary skill in the art that the features of the self checkout device may be readily applied to and implemented in the item return device, and likewise, the features of the item return device may be readily applied to an implemented in the self checkout device.

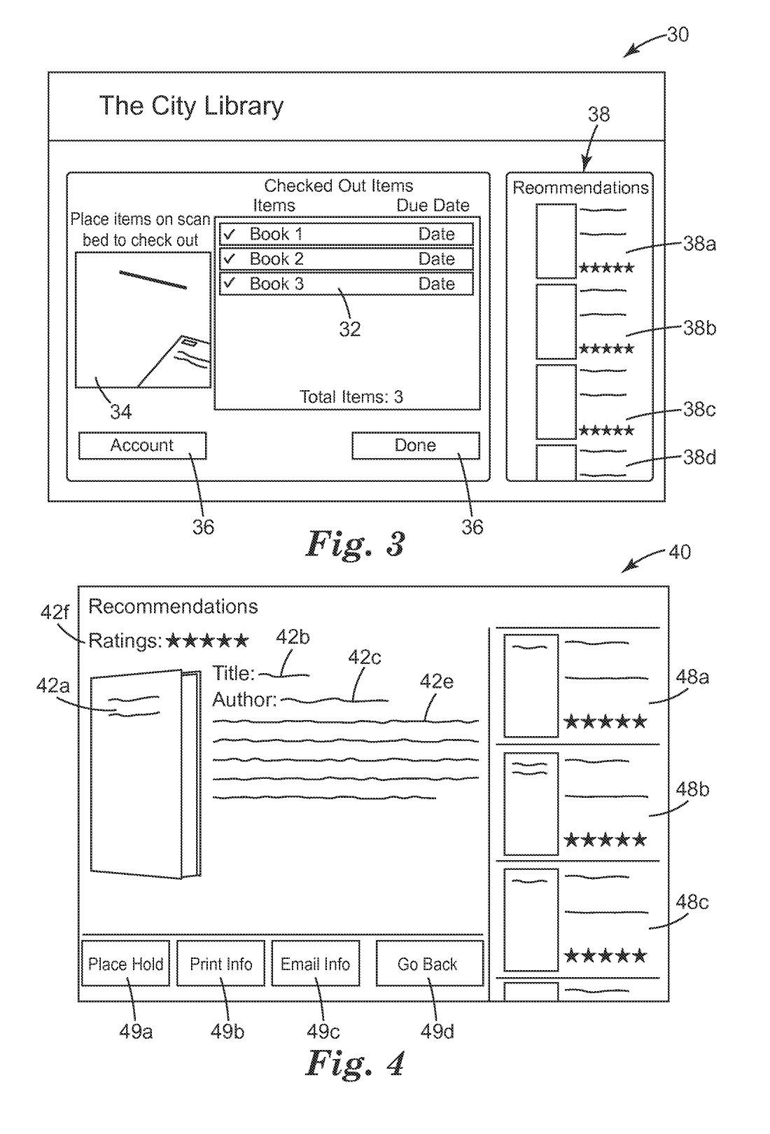

FIG. 3 is an exemplary user interface 30 that may be displayed on a self checkout or item return device display. User interface 30 may include a wide variety of configurations and sets of information. This is only an example of one way in which user interface 30 may be configured for a patron's use.

User interface 30 includes a variety of information such as items being checked out 32. In the case of an item return device, instead of displaying items being checked out 32, the user interface 30 may instead display a list of items being checked in. User interface may further provide user instructions 34 to a patron to guide the patron through the process of checking out or returning items. For example, the instructions may include directions related to presenting a patron library card to a barcode scanner, disposing the item or items in a certain location so that identifying information can be read from the items, allowing a patron to complete a session and instructing a patron to remove a receipt or other printed information from a printer slot.

User interface 30 may also include user input keys 36 which allow a patron to respond to and interact with user interface 30. User input keys 36 may allows options such as “Access Account,” “Done,” “Delete Item,” “Pay Fines” or any other variety of options.

Recommendations panel 38 is one example of how recommendations may be presented to a patron. For example, recommendations panel 38 may include multiple recommendations, such as items 38a, 38b, 38c and 38d that a patron can scroll through. The information displayed relating to an item can vary as well. For example, recommendations 38a-38d may include information such as the type of item, title, author, description, picture of the cover art, ISBN, library ID number, ratings for the book (such as a number of stars rating), and location within library. In some instances, a patron may select one of the recommendations to view further information related to such recommendation.

FIG. 4 is an example of a recommendations panel 40 providing more information relating to the recommendation. For example, this is a panel that may be displayed when a patron wishes to see more detailed identifying information 42 related to a particular recommendation. The more detailed information can include cover art 42a, title 42b, author 42c, plotline synopsis 42d and rating 42f. Additional recommendations, such as recommendations 48a, 48b and 48c may still be displayed.

Patron action keys 44a-d are shown across the bottom of the screen. Place Hold key 48a allows a patron to place a hold on the recommended item. Print Info key 48b allows a patron to print information related to the recommendation at the location such that the patron can keep the identifying information for future reference. Email Info key 48c allows a patron to email identifying information related to the recommendation for future reference or immediate reference on a handheld electronic device. Checkout key 44d allows a patron to immediately check out the item if the item is digital media. For example, a patron may immediately add the item to their account if it's an ebook, music, video, or other type of digital media.

### EXAMPLE 1

### Check Out Recommendation System

A key metric a public or local library is the quantity of items or media that is checked-out. On a continual basis, a public library desires to maintain or increase the number of items that are removed from circulation. Awareness to media that is available, in a public library, is an important factor in how the metric is improved. The self checkout device 10 represented in FIG. 1 provides an interactive system that enhances visibility to available media in a public library and increases the quantity of materials being checked-out. At the self checkout device 10, a library patron checks out an item or multiple items. In this example, the items are books. The self checkout device 10 contains a user interface 12 that instructs the patron to identify the one or more books to be checked out with an item identification component 16. The item identification component 16 contains a radio frequency identification (RFID) or barcode reader to identify a book through a barcode or RFID tag contained within the book. The self checkout device 10 may also identify the patron by reading a personal identification card that contains an RFID tag or barcode. The International Standard Book Number (ISBN) is captured by the item identification component 16 and used to identify the book. Visual representation of the book details, in the format of list, is displayed on the user interface 30 of FIG. 3. As books are checked-out, the recommendation system analyzes and locates related media contained in the local library database based on the captured ISBN. Recommendations are presented in a recommendation panel 38 to the user. Recommendations appear in an ordered list based on relevancy and availability. The patron is alerted to the status of the recommended media by interacting with the recommendation panel 38. Upon selection of a specific recommendation, another more detailed recommendation panel 40 opens and a user is presented with the ability to place a hold or reserve the book by using the patron action keys 44 as represented in FIG. 4. In a future visit to the public library, the patron checks out the book that was placed on hold.

### EXAMPLE 2

### Check In Recommendation System

When a patron has their review and use of the checked-out media, the item is returned to the public library. The item return device 20 represented in FIG. 2 is used to check-in items back into public library circulation. The item return device 20 contains a user interface 22 that instructs the patron to identify the one or more books to be checked out with an item identification component 26. The item identification component 26 contains a radio frequency identification (RFID) or barcode reader to identify a book through a barcode or RFID tag contained within the book. The item return device 20 may also identify the patron by reading a personal identification card that contains an RFID tag or barcode. The International Standard Book Number (ISBN) is captured by the item identification component 26 and used to identify the book. As books are checked-in, the recommendation system analyzes and locates related media contained in the local library database based on the captured ISBN. When a patron has completed the check-in procedure, the item return device 20 provides a printed receipt (not shown in the FIG. 2) that lists item recommendations. A patron uses the printed information to locate the recommendation during their current or subsequent visit to the library. Printed information contains at least the title, author, ISBN, or any combination therein.

What is claimed is:

1. A local library recommendation system for recommending an item available for circulation from a local library, the system comprising:
a self checkout device for use by a patron to check out an item from the local library, the self checkout device including a processor, a display for displaying information to the patron, and an item identification component;
wherein the item identification component is configured to identify the item being checked out by the patron;
wherein the display shows a recommendation of a second item based on the identification of the item being checked out by the patron; and
wherein the second item is part of the local library's collection.

2. The system of claim 1, wherein the display further provides the patron with an option to take an action related to the second item.

3. The system of claim 2, wherein the action is to print or email identifying information related to the second item.

4. The system of claim 2, wherein the action is to check the second item out or place the second item on hold.

5. The system of claim 1, wherein the item identification component is a radio frequency identification (RFID) reader.

6. The system of claim 1, wherein the item identification component is a barcode scanner.

7. The system of claim 1, wherein the second item is part of the local library's available collection.

8. The system of claim 1, wherein the recommendation of the second item is generated by an external processor.

9. The system of claim 1, wherein the recommendation of the second item is generated based on more than one item being checked out by the patron.

10. The system of claim 1, wherein the display shows multiple recommendations of items to the patron.

11. The system of claim 1, wherein the second item is a book, ebook, journal, database, DVD or CD.

12. The system of claim 1, wherein the recommendation of the second item is based on the item being checked out by the patron and at least one item the patron has historically checked out.

13. A local library recommendation system for recommending items available for circulation from a local library, the system comprising:
an item return device for use by a patron to return an item to the local library, the return device including a processor, a display for displaying information to the patron and an item identification component;
wherein the item identification component is configured to identify the item being returned by the patron;
wherein the display shows a recommendation of a second item based on the identification of the item being returned by the patron; and
wherein the second item is part of the local library's collection.

14. The system of claim 13, wherein the display further provides the patron with an option to take an action related to the second item.

15. The system of claim 14, wherein the action is to print out or email identifying information related to the second item.

16. The system of claim 14, wherein the action is to check the second item out or place the second item on hold.

17. The system of claim 13, wherein the item identification component is a radio frequency identification (RFID) reader.

18. The system of claim 13, wherein the item identification component is a barcode scanner.

19. The system of claim 13, wherein the second item is part of the library's available collection.

20. The system of claim 13, wherein recommendation of the second item is generated by an external processor.

21. The system of claim 13, wherein the recommendation of the second item is generated based on more than one item being checked out by the patron.

22. The system of claim 13, wherein the display shows multiple recommendations of items to the patron.

23. The system of claim 13, wherein the second item is a book, ebook, journal, database, DVD or CD.

24. The system of claim 13, wherein the recommendation of the second item is based on the item being checked out by the patron and at least one item the patron has historically checked out.

25. A local library recommendation system for recommending an item available for circulation from a local library, the system comprising:
a self checkout device for use by a patron to check out an item from the local library, the self checkout device including a processor, a display for displaying information to the patron, an item identification component, and a printer;
wherein the item identification component is configured to identify the item being checked out by the patron;
wherein the printer prints a recommendation of a second item on a patron receipt, the recommendation being based on the identification of the item being checked out by the patron; and
wherein the second item is part of the local library's collection.
